(19) United States
(12) Patent Application Publication
(10) Pub. No.: US 2025/0054004 A1
(43) Pub. Date: Feb. 13, 2025

(54) SYSTEMS AND METHODS FOR PROVIDING MACHINE LEARNING BASED ESTIMATIONS OF DEPOSIT ASSETS

(71) Applicant: JPMORGAN CHASE BANK, N.A., New York, NY (US)

(72) Inventors: Nader Michel GEMAYEL, Westerville, OH (US); Nicholas ROMANO, New York, NY (US); Dee PAI, Dublin, OH (US); Joshua D. SVENSON, Columbus, OH (US); Kevin MICKEY, Westerville, OH (US); Bridgette HAZELETT, Columbus, OH (US)

(21) Appl. No.: 18/796,902

(22) Filed: Aug. 7, 2024

Related U.S. Application Data
(60) Provisional application No. 63/518,079, filed on Aug. 7, 2023.

(51) Int. Cl. G06Q 30/0202; G06Q 30/0204

(52) U.S. Cl. CPC G06Q 30/0202; G06Q 30/0205

(57) ABSTRACT

In some aspects, the techniques described herein relate to a method including: generating, by a computer program including one or more machine learning models, for an input record, a predicted amount of deposit assets, wherein the predicted amount of deposit assets is for an individual or household associated with the input record; transforming, with a mathematical transformation, the predicted amount of deposit assets to match a corresponding percentile range defined in a publicly available household asset survey or benchmark; determining a final estimate for the predicted amount of deposit assets, wherein the final estimate is determined to be in proportion with an estimated total of individual or household deposits.

### RELATED APPLICATIONS

This application claims the benefit of U.S. Provisional Patent Application Ser. No. 63/518,079, filed Aug. 7, 2023. The disclosure of which is hereby incorporated, by reference, in its entirety.

### BACKGROUND

### 1. Field of the Invention

Embodiments generally relate to systems and methods for providing machine learning based estimations of deposit assets.

### 2. Description of the Related Art

Financial institutions are interested in estimating the deposit assets of individuals or households. Some data with respect to deposit assets may be known or knowable by a given institution through analysis of various data sources, both private (e.g., a bank's deposit records/ledgers) and public (published central bank data). Conventional methods of collecting, aggregating, and manipulating data, however, have been unsuccessful at accurately estimating a total of household deposit assets.

### SUMMARY

According to some embodiments, the techniques described herein relate to a method including: providing one or more machine learning models, wherein, for an input record, the one or more machine learning models output a predicted amount of deposit assets, wherein the predicted amount of deposit assets is for an individual or household associated with the input record; transforming, with a mathematical transformation, the predicted amount of deposit assets to match a corresponding percentile range defined in a publicly available household asset survey or benchmark; and determining a final estimate for the predicted amount of deposit assets, wherein the final estimate is determined to be in proportion with an estimated total of individual or household deposits.

According to some embodiments, the techniques described herein relate to a method including: generating, by a computer program including one or more machine learning models, for an input record, a predicted amount of deposit assets, wherein the predicted amount of deposit assets is for an individual or household associated with the input record; transforming, by the computer program, with a mathematical transformation, the predicted amount of deposit assets to match a corresponding percentile range defined in a publicly available household asset survey or benchmark; determining, by the computer program, a final estimate for the predicted amount of deposit assets, wherein the final estimate is determined to be in proportion with an estimated total of individual or household deposits; and allocating resources, based on the determination, to a geographic area and time.

In some embodiments, the method can further comprise normalizing results from the sub-model. In some embodiments, the method can further comprise capping accounts based on an upper limit of deposit balances. In some embodiments, the method can further comprise smoothing the deposit balances over twelve months to adjust for seasonality. In some embodiments, the allocation of resources can include scheduling support resources for an expected type of use of the financial institution. In some embodiments, the allocation of resources can include resources includes scheduling availability of network resources. In some embodiments, the mathematical transformation can include a probability integral transform.

According to some embodiments, the techniques described herein relate to a method including: training a sub-model, executed by one or more processors, on accounts existing for a time at a financial institution based on deposit balances associated with the accounts during a time window to predict synthetic balances associated with the accounts; generating, by the sub-model executed by the one or more processors, a prediction of synthetic balances for each account associated with a deposit account at the financial institution; generating, by the sub-model executed by the one or more processors, a prediction of synthetic balances for individuals in a geographic area; transforming, a computer program executed by one or more processors, with a mathematical transformation, the predicted amount of deposit assets to match a corresponding percentile range defined in a publicly available household asset survey or benchmark; determining, by the computer program, a final estimate for the predicted amount of deposit assets, wherein the final estimate is determined to be in proportion with an estimated total of individual or household deposits; and allocating resources, based on the determination, to a geographic area and time.

In some embodiments, the method can further comprise normalizing results from the sub-model. In some embodiments, the method can further comprise capping accounts based on an upper limit of deposit balances. In some embodiments, the method can further comprise smoothing the deposit balances over twelve months to adjust for seasonality. In some embodiments, the allocation of resources can include scheduling support resources for an expected type of use of the financial institution. In some embodiments, the allocation of resources can include resources includes scheduling availability of network resources. In some embodiments, the mathematical transformation can include a probability integral transform.

Systems and hardware described herein include processors configured to execute computer programs that include instructions comprising methods consistent with disclosed embodiments.

### BRIEF DESCRIPTION OF THE DRAWINGS

FIG. 1 is a block diagram for providing machine learning based estimations of deposit assets.

FIG. 2 is a logical flow for providing machine learning based estimations of deposit assets.

FIG. 3 is a logical flow for providing machine learning based estimations of deposit assets.

FIG. 4 is a logical flow for feature selection.

FIG. 5 is a block diagram of a computing device for implementing certain aspects of the present disclosure.

### DETAILED DESCRIPTION

Embodiments generally relate to systems and methods for providing machine learning based estimations of deposit assets.

Conventionally, a financial institution may only know, as a certainty, a total number of deposit assets that are deposited at the institution. There is no obtainable data that indicates a total number of deposit assets, or a number of deposit assets at other institutions. Aspects discussed herein provide systems and methods for an accurate estimation of all household deposit assets in an area using machine learning, private customer data of a financial institution, and publicly available financial information.

According to some embodiments, a financial institution (sometimes referred to as a providing institution, herein) may provide one or more semi-supervised machine learning algorithms that may train one or more machine learning (ML) models to predict a synthetic deposit asset amount based on input data. Output from one or more ML models may be combined with an allocation method that may be used to cascade national benchmarks for total deposit assets held by households across households in various geographies while considering and aligning with data provided by, e.g., census agencies, central banks, etc., with respect to typical funds of relevant households.

Embodiments may rely on customer profile data collected by an institution as input to a machine learning model. For instance, a financial institution may collect financial information about customers. Exemplary profile data that may be collected by a financial institution may include deposit data, credit card data (e.g., account holders, credit card spends, spending categories, balances, etc.), mortgage data, vehicle loan data, investment data, and other forms of financial data).

Moreover, a financial institution may collect and/or purchase various demographic data, such as whether an individual is a homeowner or a home renter, home values for individuals, home location, etc. Such data may be collected by a financial institution and stored in one or more datasets. According to some embodiments, an institution may keep a first datastore for customer demographic data and a second datastore for purchased (i.e., external) demographic data. Institutions may store datasets in any suitable manner, such as in relational databases, data warehouses, data lakes, etc.

According to some embodiments, customer data may also be aggregated at a geographic level. That is, data records for customers that reside in a given geographic area may be related based on the common geographic area. Geo-aggregated customer data may also include averages of financial data for a given geographic area. For instance, for a given geographic area, geo-aggregated data may include an average of deposit assets at a providing institution, an average credit card spend, an average credit card balance, an average home value, an average mortgage balance, etc. (i.e., averages at a particular geographic level). An exemplary geographic area is a block group. A block group is a statistical division of census tracts. Block groups generally contain between 600 and 3000 people. Other exemplary geographic areas include townships, counties, etc. Storage relations may be affected through any suitable manner, such as a common logical or physical storage location, a primary/secondary key relationship, etc.

According to some embodiments, an institution may provide a ML model for customers (i.e., a customer ML model) that predicts, for each customer record in one or more datasets, a total amount of deposit assets for a customer associated with a record. A customer ML model may take data records from each of a customer profile datastore, a geo-aggregated data store, and a demographics data store as input to the model, and for each customer record, may output a prediction of total deposit assets for a customer associated with each input record. Customer ML model output may predict a total of a customer's deposit assets, from which an amount of a customer's deposit assets that are deposited with one or more other institutions may be derived, since an amount of a customer's deposit assets that are deposited with the providing institution are known.

According to some embodiments, a financial institution may further provide a ML model for customer prospects (i.e., a prospect ML model) that predicts, for each customer prospect record in one or more datasets, a total amount of deposit assets for a customer prospect associated with a record. A prospect ML model may take data records from each of a geo-aggregated datastore, and a demographics datastore, and may additionally take output from a customer ML model, as input to the prospect ML model. For each input record, a prospect model may output a prediction of total deposit assets for a customer prospect associated with each input record.

According to some embodiments, model output from the models discussed above may tend to reflect a relative amount of deposit assets per analyzed record due to variances and trends in individuals that bank with a providing institution. That is, because different institutions may attract and service customers that belong to different socioeconomic strata (respectively), model output may not be a good literal estimate of deposit assets. Additional processing in light of additional data may be provided to arrive at a more accurate literal estimate of deposit assets owned by an individual associated with a given data record (whether customer or prospect).

According to some embodiments, output from a customer ML model and/or a prospect ML model may be further processed using an allocation process in order to provide a more accurate literal deposit asset estimation. An allocation process may check an ML model estimation for customer-based records against actual deposits in order to determine that an estimation is not incorrect with respect to a known balance. For instance, if a known balance of a customer is $20,000 U.S. dollars (USD), then an estimate for a record associated with the customer should be at least $20,000 USD. If the estimate is less than the actual amount, the estimate may be disregarded or adjusted.

Moreover, an allocation process may transform raw model output using a mathematical transformation (such as the probability integral transform) to map raw model output numbers for a given record to match an appropriate range in a publicly available household asset survey or benchmark. A publicly available household asset survey may publish household or individual assets and, with respect to assets that may be deposited, may be expressed as a percentile ranking (i.e., ranges such as 10th percentile, 20th percentile, 25th percentile, 50th percentile, 90th percentile, etc.). An exemplary survey of assets that is publicly available is the Survey of Consumer Finances that is conducted and published by the Federal Reserve Bank of the United States (i.e., the central bank of the United States) once every 3 years.

According to some embodiments, an allocation process may additionally consider an estimated total of household deposits and may determine a final estimate for an analyzed record that is in proportion to the estimated total of household deposits, such that the total of all individual or household deposit assets sum to approximately the estimated total. An estimated total may be estimated by using public data such as the M2 and H2 money supply published by the Federal Reserve Bank of the United States, and other public deposit data published by organizations such as the Federal Deposit Insurance Corporation, the National Credit Union Association, etc.

According to some embodiments, an allocation process may additionally consider an estimated total of household deposits and may determine a final estimate for an analyzed record that is in proportion to the estimated total of household deposits, such that the total of all individual or household deposit assets sum to approximately the estimated total. An estimated total may be estimated by using public data such as the M2 and H2 money supply published by the Federal Reserve Bank of the United States, and other public deposit data published by organizations such as the Federal Deposit Insurance Corporation, the National Credit Union Association, etc.

According to some embodiments, different sub-populations offer different amounts of relevant predictive information. Specifically, households that have a deposit relationship with a financial institution offer the most in terms of potential input features, and those that have a non-deposit relationship with the financial institution offer less, while those that have no relationship offer little information (e.g., a survey, an interest document) or none. As a consequence, models consistent with the present disclosure are trained in a semi-supervised or automated fashion in order to maximize the information available for each sub-population. An initial sub-model that is trained on households with sustained relationships with the financial institution can be applied to other customer households in order to predict synthetic balances—what their deposit balances would have been if they had such a sustained relationship. The combination of actual balances of households with sustained relationships and synthetic balances of other deposit households forms the target for a second sub-model, that predicts synthetic balances of non-deposit customer households. A similar procedure is then used to train a third sub-model, that predicts synthetic balances of prospect households.

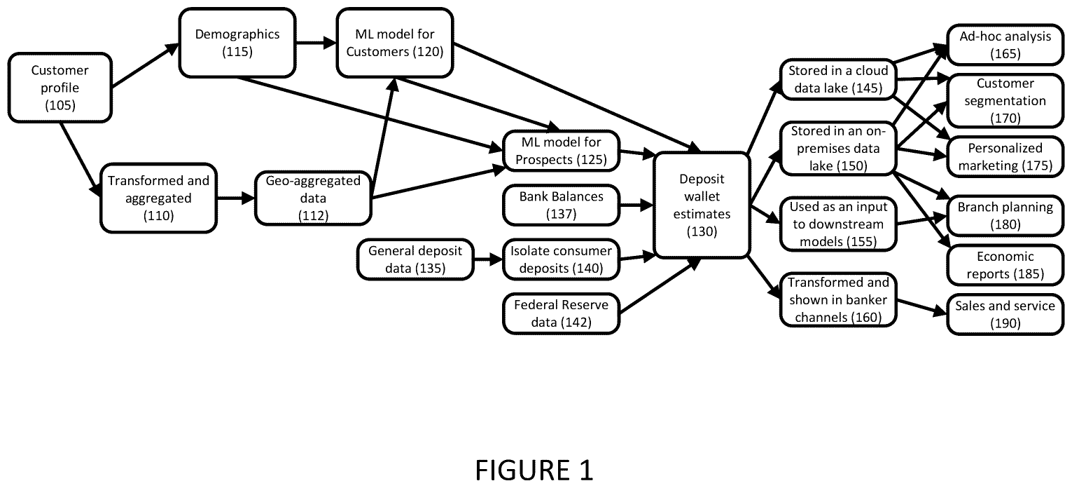

FIG. 1 is a block diagram for providing machine learning based estimations of deposit assets.

A customer profile 105 can be on-premises or part of a cloud data lake. The customer profile 105 can be transformed and aggregated 110 to create geo-aggregated data 112.

Demographics 115 can also be on-premises or part of a cloud data lake. The demographics 115, the customer profile 105, and the geo-aggregated data 110 can be input into a machine learning model for customers 120.

The output of machine learning model for customer 120 can be used for a machine learning model for prospects 125, as well as the demographics data 115 and the geo-aggregated data 110. The output of the two machine learning models 120, 125 can be input into a deposit wallet estimate 130.

The deposit wallet estimate 130 can also use deposit data 135 (e.g., from the Federal Deposit Insurance Corporation (FDIC) and the National Credit Union Administration (NCUA)) that can be capped to isolate consumer deposits 140. The deposit wallet estimate can also use one or more bank balances from a financial institution 137. The deposit wallet estimate 130 can also use deposit information from Federal Reserve's Survey of Consumer Finances (SCF) 142.

The output of deposit wallet estimate 130 can be stored in a cloud data lake 145, stored in an on-premises data lake 150, used as an input to downstream models 155, and transformed and shown in banker channels 160. The cloud data lake 145 can be used for ad-hoc analytics 165, customer segmentation 170, and/or personalized marketing 175. The on-premises data lake 150 can be used for analytics 165, customer segmentation 170, personalized marketing 175, branch planning 180, and economic reports 185. The input for downstream models 155 can be used for personalized marketing 175 and branch planning 180. The transformed estimate can be used for sales and service 190.

Outputs of the deposit wallet estimate 130 can further be used to allocate local resources according to the number and type of accounts held in a geographic area. For example, allocations can occur for categories including rewards, everyday banking, and commercial transactions based the wallet estimate. Allocations can include company resources such as bandwidth, scheduling work hours, or building systems or buildings to address particular needs. For example, work hours for a banking need (e.g., sales, account support, checking, clearing) can be scheduled for a time and geographic area based on the estimated number of accounts in the geographic area for the time (e.g., during working hours). As another example, marketing and/or personalized communications can be generated for the geographic area. As another example, a new branch could be built in a particular geographic area based on the estimates and the type of banking needed (e.g., commercial, checking, deposit, loans, etc.).

Further, the opportunity to deploy additional branch, virtual branch, or local advertising can be based on the deposit estimate. Deposit opportunity is instrumental to determining whether and where to allocate resources.

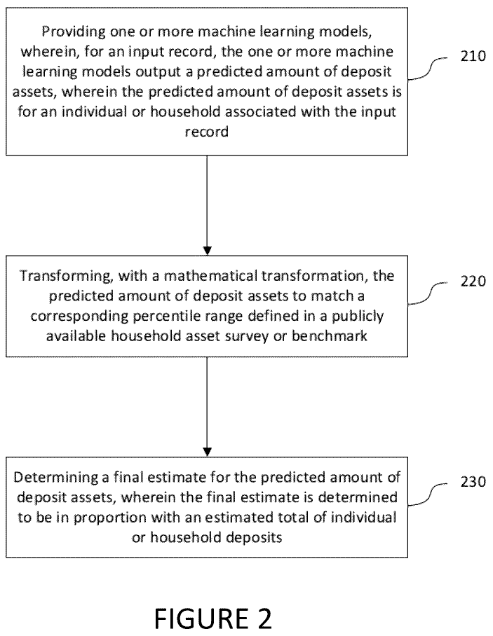

FIG. 2 is a logical flow for providing machine learning based estimations of deposit assets.

Step 210 includes providing one or more machine learning models, wherein, for an input record, the one or more machine learning models output a predicted amount of deposit assets, wherein the predicted amount of deposit assets is for an individual or household associated with the input record.

For example, to ensure apples-to-apples comparison, sub-model scores are normalized, by comparing the outputs of different sub-models for households that can be scored by more than one of the sub-models.

Step 220 includes transforming, with a mathematical transformation, the predicted amount of deposit assets to match a corresponding percentile range defined in a publicly available household asset survey or benchmark.

This is accomplished in part by training a sub-model on deposit customers to predict the synthetic balances of customer households who are not deposit customers (i.e., their products could include branded credit cards, mortgage or home equity, or auto loans, but no deposit accounts). For the non-deposit customer sub-model, the dependent variable reflects the mix of households present in the training data: both loyal and other deposit households. Loyal households have a 12-month average deposit balance as their target. Other deposit households have the output of the deposit customer model as their target, which can be interpreted as a synthetic balance.

Next, the sub-model can be trained on loyal households' deposit balances to predict the synthetic deposit balances for all deposit customer households. For the deposit customer sub-model, the dependent variable corresponds to the actual deposit balances of loyal households. To smooth out seasonality effects (more specifically, interactions between seasonality and various features on deposit balance), the deposit balances are averaged over a period of time (e.g., 12 months). Note that this is also the time window to see if a household meets the qualifying criteria for being loyal (e.g., including criteria such as bank status, existence of checking, savings, and investment accounts, and with no external money flows).

Next, the sub-model can be trained on customer households to predict the synthetic balances of the prospect households. For the prospect sub-model, the dependent variable reflects the mix of households present in the training data: loyal households, other deposit households, and non-deposit customer households. Loyal households can have an average deposit balance over a time period (e.g., 12 months) as their target. Other deposit households have the output of the deposit customer model as their target, which can be interpreted as a synthetic balance. Non-deposit customer households have the output of the non-deposit customer model as their target.

Additionally, a “deposit wallet index” for each household is created by applying the probability integral transform to model outputs to map each quantile to a corresponding quantile of deposit wallet reported in the Federal Reserve's Survey of Consumer Finances (SCF).

Step 230 includes determining a final estimate for the predicted amount of deposit assets, wherein the final estimate is determined to be in proportion with an estimated total of individual or household deposits.

For example, for each market area (e.g., also known as a designated market area (DMA)), the amount of total deposits held by consumer households is estimated based on data of publicly reported deposits held by each branch of a bank or credit union. Subtracting the known deposit balances held at a financial institution from the grand total gives a total amount of consumer deposits held in non-affiliated accounts by households within each DMA.

A Bayesian approach produces a final deposit wallet estimate by allocating a portion of deposits to each household, based on their deposit wallet index and their known deposit balance.

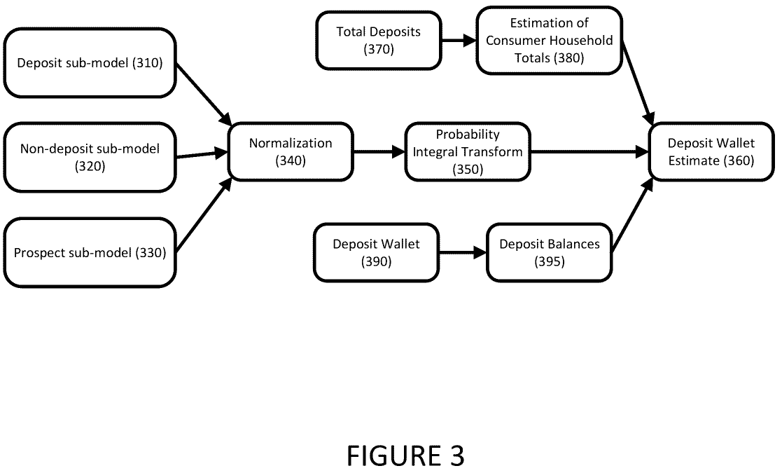

FIG. 3 is a block diagram for providing machine learning based estimations of deposit assets.

Consistent with disclosed embodiments, sub-model 310 can be trained on known, sustained (e.g., loyal) deposit accounts. The amount of time, volume, and types of accounts can be selected to determine what is loyal. Next, a sub-model 320 can train on deposits for those who are somewhat known (e.g., have one or more accounts, have an account less than the amount of time, have volume less than a threshold). Next, a sub-model 330 can train on deposits for unknown or prospective individuals or households.

The sub-models can be applied to blocks of populations acquired from census, survey data, household data, and known customer information. The blocks can be tracked appropriate to their geographic area.

Sub-models, including deposit sub-model 310, non-deposit sub-model 320, and prospect sub-model 330, can be aggregated and normalized into a normalized data 340.

Normalization data 440 can be used because each sub-model may not necessarily produce outputs on the same scale, and so to ensure an apples-to-apples comparison, outputs are normalized, by comparing the outputs of different sub-models for households that can be scored by more than one of the sub-models. Prior to normalization, each household in the deposit customer population has scores available from the deposit sub-model 310, non-deposit sub-model 320, and prospect sub-model 330, each household in the non-deposit customer population has scores available from the non-deposit sub-model 320 and prospect sub-model 330, and each household in the prospect population has a score available from the prospect sub-model 330. After normalization, each household has one normalized score.

The priority throughout this normalization is relative ranking of households, and so direct model outputs for deposit customer households from the deposit customer sub-model are taken as the base level of comparison, without need for normalization. Note that loyal households, while useful in model training, may be treated as other deposit customer households are treated for the purpose of producing final wallet estimates, by using their deposit sub-model score at this point.

$${y}_{i , normalized} = {y}_{i , deposit model}$$

where household i is a deposit customer and y_{i, deposit model} is the prediction for this household from the deposit household sub-model.

For non-deposit customer households, they cannot be scored by the deposit customer sub-model 320, and so a direct apples-to-apples comparison is not possible. Instead, the output of the most informative sub-model available for this population, the non-deposit customer sub-model 330, is used as the baseline for normalization. To normalize these scores, a ratio is calculated by looking at deposit customer households, who can be scored by both sub-models in question. Note that while there are cases where y values can be zero or negative, the sums across these populations, and therefore their ratios, are positive due to the rarity of these cases.

$${y}_{i , normalized} = {y}_{i , non - deposit model} \times \frac{average [ {y}_{j , normalized} : all deposit customers j ]}{average [ {y}_{j , non - deposit model} : all deposit customers j ]}$$

where household i is a non-deposit customer and y_{i, non-deposit model} is the prediction for this household from the non-deposit customer model.

The normalized data 340 can be provided to a probability integral transform 350.

For the transform 350, the output of each sub-model can be interpreted as a synthetic balance, if each household scored were loyal (see definition above), and so these outputs may not be distributed as deposit wallets should be distributed, for several reasons. First, the distribution of loyal households is likely to be not nationally representative due to the criteria used to define the loyal population, including requiring a term relationship (e.g., a year) with a financial institution, and requiring an investment account. This bias would cause the lower end of the output distribution to be higher than the lower end of the true deposit wallet distribution. Second, loyal households have shown no evidence of external accounts, but many may nevertheless have external deposit accounts which have had no recent flows. This unobserved portion would cause some parts of the output distribution to be lower than the true deposit wallet distribution. Finally, a model designed to optimize a least squares criterion, such as this application of the model, may show regression toward the mean, reflecting underlying uncertainty in estimates.

Indeed, the distribution of normalized sub-model outputs and the distribution of deposit wallets reported in the Federal Reserve's Survey of Consumer Finances (SCF) have noticeable differences. The SCF is conducted every three years, and so for June 2022, the 2019 SCF would have been the most recent available survey. It included responses from 5,777 anonymous households, each of which are assigned a weight to calculate values that are nationally representative. Deposit wallet in SCF terms is equal to the sum of balances in all transactions accounts (LIQ) and certificates of deposit (CDS), excluding money market mutual funds (MMMF) which would fall in investment wallet. According to the distribution reported in the SCF, there are many more households with low deposit wallets, as well as more households on the very high end of deposit wallets.

To remedy these potential distributional issues, the probability integral transform 350, also known as quantile matching, can be applied to the collection of normalized sub-model outputs. As shown in FIG. 3., the deposit wallet estimate 390 can also use SCF deposit wallet data 490 that are used to find deposit balances 395, consistent with disclosed embodiments discussed herein. The calculation maps values of a reference distribution (SCF deposit wallet) can be applied as new values for each quantile a target distribution (quantiles of sub-model outputs). To achieve this computationally, exact quantiles of the normalized scores can be mapped to one of 10,000 exact quantiles of SCF deposit wallet values, using linear interpolation if the score quantile fell between the nearest two SCF quantiles. That is, a score with quantile of 0.77775 can be mapped to halfway between the values of SCF quantiles 0.7777 and 0.7778. As an example, low normalized sub-model outputs can be mapped to even lower values, and some of the highest normalized sub-model outputs can be mapped to even higher values. As noted, this transform can occur to the sub-model outputs based in part on SCF deposit wallet data 390 and resulting deposit balances 395. The resulting transform 350 can be used by the deposit wallet estimate 360.

The deposit wallet estimate 360 can use gradient boosting with regularization to build a predictive model using an ensemble of “weak” learners like decision trees. The model is built in an additive stage-wise approach with each tree being trained on the residuals output from the preceding tree. The final prediction is achieved by taking a weighted combination of the outputs of the individual trees. The role of regularization in the model is to reduce the overall complexity of the weak learners and to prevent over-fitting.

Prospect households cannot be scored by the deposit customer sub-model 310 or the non-deposit customer sub-model 320, and so the only available output is that of the prospect sub-model 330. To normalize these scores, a ratio is calculated by looking at customer households (both deposit and non-deposit), who can be scored by the prospect model but also have already normalized scores from previous sub-models.

$${y}_{i , normalized} = {y}_{i , prospect model} \cdot \frac{average [ {y}_{j , normalized} : all customers j ]}{average [ {y}_{j , prospect model} : all customers j ]}$$

where household i is a prospect.

The model estimation process involves the following three stages: Hyper-parameter tuning, variable selection, and final model build. Hyper parameter tuning can include parameters including:
Booster: tree-based models or linear models can be selected.
N_jobs: the number of parallel threads used to run the model.
N_estimators: the number of iterations or the number of trees in the model. At every iteration of the algorithm, a new tree is constructed based on the loss function gradient of the previous iteration.
Max_depth: the maximum number of splits or levels a tree may have on one branch. A model based on trees with many levels is more complex, but increases the chance of overfitting. Shallow trees may not be able to account for subtle patterns in the data, and thus may not be as accurate. The choice of the value of max_depth is made jointly with other hyper-parameters that control the loss function, such as lambda and alpha.
Subsample: the fraction of the data to be subsampled, each tree that is developed is typically complex and increases the possibility of overfitting. However, very small values of subsample may lead to underfitting.
Colsample_bytree: the fraction of variables that are randomly chosen for consideration for each tree. For example, if colsample_bytree is 0.5, the algorithm will randomly subsample half of the variables in the data at every iteration. Larger values make the algorithm less conservative by allowing more complexity, thus increasing the chance of overfitting.
Colsample_bylevel: the subsample ratio of columns for each split within a tree. Subsampling occurs each time a new split is made during the construction of a tree. For instance, if the value of colsample_bylevel is 0.2, the algorithm will use 20% of the variables that are sampled to construct the tree as specified by colsample_bytree, to construct a split in the decision tree. Larger values make the algorithm less conservative by allowing more complexity, thus increasing the chance of overfitting.
Tree_method: allows specification of the tree construction algorithm. There are two ways of generating a split to construct the tree: the exact greedy algorithm (tree_method=exact) and the approximate algorithm (tree_method=approx). If the default option auto is set, the algorithm uses the exact greedy algorithm for small and medium datasets and the approximate algorithm for large datasets.
Min_child_weight: specifies the minimum sum of weights (or Hessian of all weights) of all observations in a partition of a node. If the partition results in a node with the sum of weights less than min_child_weight, the tree building process will not partition further. This hyper-parameter effectively controls the sample size required for further splitting. A larger value makes the model more conservative by preventing deeper trees, thus decreasing the chance of overfitting.
Learning rate (or shrinkage): controls the contribution of each tree to the final prediction. The values of eta range between 0 and 1. Larger values of the learning rate mean the model will account for much of the data during early iterations, thereby reducing computation time, but also decreasing the out-of-sample accuracy. However, lowering the value of eta increases the number of iterations and thus the algorithm can get computationally cumbersome.
Gamma: component of the penalty term:

$$Ω ( f ) = {\sum }_{k = 1}^{K} γ {T}_{k} + \frac{1}{2} λ {‖ {w}_{k} ‖}^{2} + α ‖ {w}_{k} ‖$$

that specifies the minimum loss reduction required to make a split during the tree construction. A larger value of gamma makes the model more conservative in the sense that it prevents more complex trees, thus decreasing the chance of overfitting.
Reg_lambda: the scaling value for the L2 norm of the leaf scores in the loss function, Ω(f). Just like gamma, a larger value of lambda will make the model more conservative, thus decreasing the chance of overfitting.
Reg_alpha: an additional term on the leaf scores in an expanded loss function, Ω(f), that scales the L1 norm of the leaf scores. L1 regularization plays a similar role as L2, with the major difference being that L1 focuses on the gradient of the leaves instead of the Hessian. L1 regularization has the ability to shrink the leaf weights to zero. Modelers often tune this hyper-parameter for cases when very deep trees are allowed. Larger alpha will make the model more conservative, thus decreasing the chance of overfitting.
Scale_pos_weight: controls the balance of positive and negative weights. It is particularly useful for unbalanced classes. For instance, for a dataset that has 90% negative observations and 10% positive observations, the value of scale_pos_weight would be set to 9.
Objective: defines the specification of the loss function to be minimized. Some values commonly used are: 1. linear regression, 2. logistic regression, 3. multi-class classification using a soft max objective.
Seed: specifies the seed value for generating random numbers. To obtain model results that are reproducible, the value of seed is kept fixed before running the model.

The hyper-parameter tuning may be conducted via Bayesian optimization, which builds a surrogate model for the objective and quantifies the uncertainty in that surrogate model using a Gaussian process regression (probability distribution over a function space) and then uses an acquisition function defined from this surrogate to decide where to sample for the next evaluation with best performance potential. The surrogate model is easier to optimize than the objective function. Hyper-parameters that perform best on the surrogate function are selected and evaluated on the actual objective function.

Initially in the optimization process, the dataset may be split into development and test with stratified sampling on target variable. By putting the test set aside, the Bayesian optimization process is started based on the k-fold cross-validation performance on the development set.

At the first iteration, a number of hyper-parameter combinations can be randomly initialized from the pre-defined hyper-parameter space. Then, the objective function is evaluated at all the initialized hyper-parameter combinations. By leveraging the results of the evaluated combinations, the Gaussian process (surrogate model) is constructed to define a prior distribution over the objective function. Next, the acquisition function is defined as lower confidence bound (LCB), which is the mean of Gaussian distribution minus two standard deviations. It is used to propose the next sampling points over the Gaussian process to generate potentially improved cross-validation performance. This acquisition function trades off exploitation and exploration. Exploitation means sampling where the surrogate model predicts a high objective and exploration means sampling at locations where the prediction uncertainty is high. Both correspond to high acquisition function values and the goal is to maximize the acquisition function to determine the next sampling point. In the following iteration, the newly sampled hyper-parameter combination will be evaluated on the objective function and then the result will be used to update the existing Gaussian process. This Bayesian optimization process will repeat until the number of iterations reaches the defined threshold. At the end of the process, the hyper-parameter combination with the best k-fold cross-validation performance is chosen. To prevent overfitting the model, an early stopping mechanism is imposed. Although the “n_estimators” parameters is set to the max number of 800, there are instances where a model will have fewer than 800 trees.

After selecting the optimal set of hyper-parameters using the Bayesian optimization strategy described above, the final model estimates are then obtained by developing the model on the training dataset using these optimal set of values. The final model performance is evaluated by calculating the performance metrics on the testing dataset.

The model's methodology can incorporate randomness into the model building process. At each stage of tree building, the attributes are chosen randomly based on the column sampling by tree parameter. Thus, given the same set of hyper-parameter values, the final model obtained using the same development dataset may be different if the model estimation process is repeated. However, the final performance of models obtained from such repeated runs are expected to be similar due to the following reasons:
Final model prediction is a weighted average of many ensemble trees, which reduces the variance in the final model output and thereby stabilizes the model performance.
The optimal set of hyper-parameter values are obtained using a Bayesian optimization strategy that is based on robust estimates of training and validation performance metrics obtained using a 4-fold cross-validation. A default can be used to balance trade-offs between the higher sample size of training data and more points contributing to a mean performance estimate with higher number of folds, and the higher sample size of validation data and lower computational cost of fewer folds.

The model's methodology can allow for inherent variable selection by adding regularization terms to the objective function. Particularly, the L1-norm on the weights of the trees facilitates variable selection. The sparsity is controlled by varying the hyper-parameter alpha, with higher values promoting sparse models. For each base tree classifier, variable selection may be performed intrinsically by selecting appropriate split points at each tree node. The relevance of each variable on the response can be measured by feature importance, which is defined as the impurity reduction when this variable is used to split a node in the base tree classifier.

As noted above, the final wallet estimates can be produced by taking the transform 340 of the sub-models 310, 320, and 330, and then for each media area, estimating total deposits held by consumer households. Known deposit balances can be subtracted from the estimate to determine deposits not affiliated with the financial institution. Finally, the Bayesian approach discussed above produces the final wallet estimates by, for example, allocating a portion of non-affiliated deposits to each household based on the deposit wallet index and known deposit balances at the financial institution.

The Bayesian approach includes splitting the known non-affiliated deposit balances F into a portion F·α held by households who are deposit prospects and a remainder F·(1−α) that deposit customers keep at other financial institutions. It further splits the non-affiliated balances F·(1−α) among deposit customers in proportion to their relative weight in the Deposit Wallet Index (relative to the other deposit customers). Similarly, it splits F·α among prospects in proportion to their relative weight among the other prospects in the Deposit Wallet Index In this way, the Bayesian approach can estimate a loyal deposit household's wallet to be at least as large as their deposit balances.

The model has advantages including improved prediction accuracy because its iterative construction and complexity allows it to identify more subtle patterns from a larger set of explanatory variables than a linear classifier, such as logistic regression. Another advantage is less restrictive assumptions because the model is a non-parametric method and its pattern recognition is not limited by a functional form. Furthermore, the algorithm is also capable of processing highly correlated candidate variables without adverse impacts on estimation. Another advantage is reduced or no manual input because the input data requires minimal or no cleaning because the model can select and transform variables automatically, reducing manual errors. Another advantage is scalability because the model can run on parallel and distributed computing platforms.

Another advantage is reduced memory use because the use of out-of-core computation methods that leverage disk space memory and/or processor memory. Another advantage is sorting because the model sorts the data once and then stores the data into blocks of in-memory units rather than re-sorting the data repeatedly. Another advantage are categorical variables because the model encodes categorical variables by converting the categorical variables into a vector that can be sorted rather than considering the outcomes from all the categorical values. This encoding method results in a sparse data set, and the model can handle sparse data efficiently. Another advantage are the handling of missing values without imputation and/or proxies. Another advantage is minimizing a computationally more convenient approximate loss function rather than the actual loss function.

Furthermore, the model reduces computational time by finding the local error minimum in each iteration, at the expense of not explicitly searching for the global error minimum. The loss function L(y, f(x)) optimized by the model is defined as the loss incurred by using the predictor f(x) when the true value is y. The loss function is dictated by the problem at hand. In applications with a continuous target variable, such as a dollar amount, the loss function is the Error Sum of Squares, defined as L(y,f(x))=(y−f(x))\hat{ }2, whereas in applications with a binary outcome (y∈{0,1}), the loss function is the negative of the binomial log likelihood function:

$$L ( y , f ( x ) ) = - [ y \cdot log ( f ( x ) ) + ( 1 - y ) \cdot log ( 1 - f ( x ) ) ]$$

In either case, the optimization problem can be stated as:

$${min}_{f} {\sum }_{i} L ( {y}_{i} , f ( {x}_{i} ) ) + Ω ( f )$$

where i indexes the training dataset and Ω(f) is the penalty function that regularizes the complexity of the target function f. The penalty function, also known as the regularization term, helps to avoid over-fitting by preventing the model from getting too complex. If Ω(f)=0, then the model reduces to a standard gradient boosting tree method. The target function f for the model is estimated by an aggregation of decision trees built one-at-a-time in series. That is, f=Σₖ₌₀^{K} ƒₖ, where k indexes the iterations.

The deposit wallet estimate 360 can also use total deposits by media area 370 that are used for an estimation of consumer household totals 380, consistent with disclosed embodiments discussed herein.

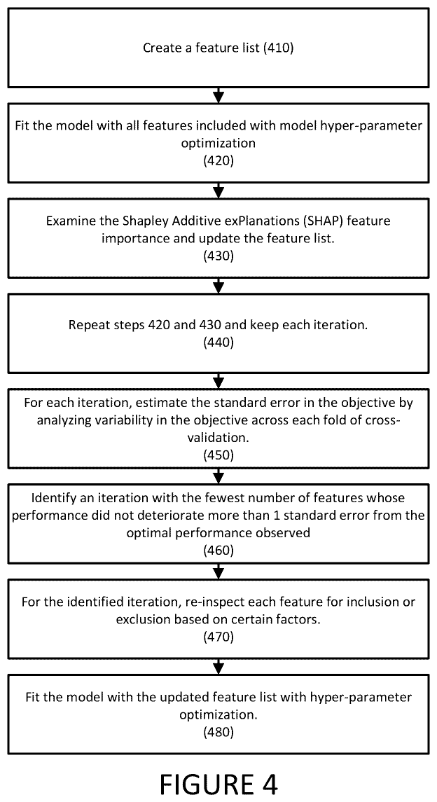

FIG. 4 is a logical flow for feature selection, consistent with disclosed embodiments.

Features can be input data to sub-models. They can be geo-aggregated features that can apply to any individual or household. Features are also input as criteria into tree nodes of the final deposit estimate as discussed above. Reduction in feature selection may be achieved by performing recursive feature elimination (RFE) according to one or more steps:
1. Step 410: Create a feature list, which can include all the features in the list. The feature list can exclude features missing over 80% of observations, as well as unstable variables, such as those that rely on subjective business descriptors that changes over time.
2. Step 420: Fit the model with all the features included with model hyper-parameter optimization.
3. Step 430: Examine the Shapley Additive exPlanations (SHAP) feature importance and update the feature list. For example, features can be included that are responsible for the top 90% of SHAP importance, and removing all other features can be removed.
4. Step 440: Repeat steps 420 and 430. The steps can be repeated several times by re-fitting the model using the model with an updated feature list and hyper-parameter optimization.
5. Step 450: For each iteration, estimate the standard error in the objective (mean squared error) by analyzing variability in the objective across each fold of cross-validation.
6. Step 460: Identify the iteration with the fewest number of features whose performance did not deteriorate more than 1 standard error from the optimal performance observed.
7. Step 470: For this iteration's set of features, re-inspect each feature for inclusion or exclusion based on several factors. The factors may include one or more of simplicity, causal relevance to overall project, and maintainability in implementation.
8. Step 480: Fit the model with the updated feature list with hyper-parameter optimization.

Note that both the initial and final number of features corresponded with the amount of information available for each population: greatest for the deposit sub-model, and fewest for the prospect sub-model.

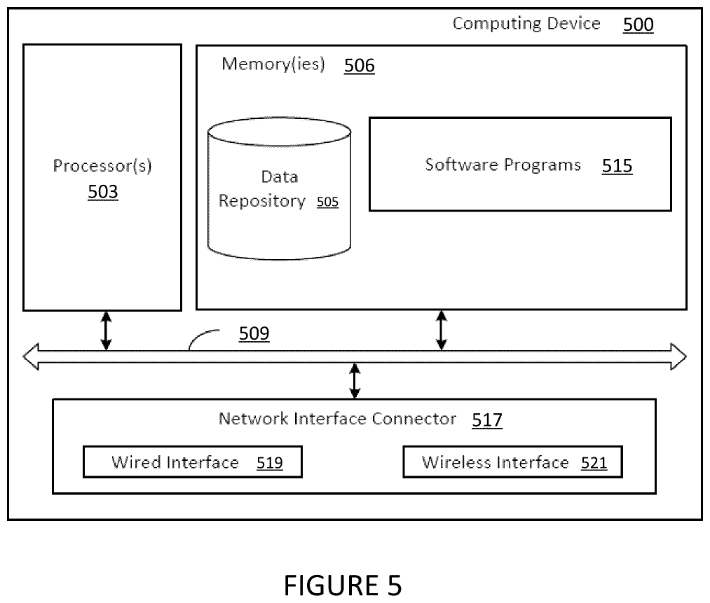

FIG. 5 is a block diagram of a computing device for implementing certain aspects of the present disclosure. FIG. 5 depicts exemplary computing device 500. Computing device 500 may represent hardware that executes the logic that drives the various system components described herein. For example, system components such as a ML model engine, an interface, various database engines and database servers, and other computer applications and logic may include, and/or execute on, components and configurations like, or similar to, computing device 500.

Computing device 500 includes a processor 503 coupled to a memory 506. Memory 506 may include volatile memory and/or persistent memory. The processor 503 executes computer-executable program code stored in memory 506, such as software programs 515. Software programs 515 may include one or more of the logical steps disclosed herein as a programmatic instruction, which can be executed by processor 503. Memory 506 may also include data repository 505, which may be nonvolatile memory for data persistence. The processor 503 and the memory 506 may be coupled by a bus 509. In some examples, the bus 509 may also be coupled to one or more network interface connectors 517, such as wired network interface 519, and/or wireless network interface 521. Computing device 500 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
generating, by a computer program including one or more machine learning models, for an input record, a predicted amount of deposit assets, wherein the predicted amount of deposit assets is for an individual or household associated with the input record;
transforming, by the computer program, with a mathematical transformation, the predicted amount of deposit assets to match a corresponding percentile range defined in a publicly available household asset survey or benchmark;
determining, by the computer program, a final estimate for the predicted amount of deposit assets, wherein the final estimate is determined to be in proportion with an estimated total of individual or household deposits; and
allocating resources, based on the determination, to a geographic area and time.

2. The method of claim 1, further comprising normalizing results from the sub-model.

3. The method of claim 1, further comprising capping accounts based on an upper limit of deposit balances.

4. The method of claim 1, further comprising smoothing the deposit assets over twelve months to adjust for seasonality.

5. The method of claim 1, wherein allocating resources includes scheduling support resources for an expected type of use of the financial institution.

6. The method of claim 1, wherein allocating resources includes scheduling availability of network resources.

7. The method of claim 1, wherein the mathematical transformation includes a probability integral transform.

8. A method comprising:
training a sub-model, executed by one or more processors, on accounts existing for a time at a financial institution based on deposit balances associated with the accounts during a time window to predict synthetic balances associated with the accounts;
generating, by the sub-model executed by the one or more processors, a prediction of synthetic balances for each account associated with a deposit account at the financial institution;
generating, by the sub-model executed by the one or more processors, a prediction of synthetic balances for individuals in a geographic area;
transforming, a computer program executed by one or more processors, with a mathematical transformation, the predicted amount of deposit assets to match a corresponding percentile range defined in a publicly available household asset survey or benchmark;
determining, by the computer program, a final estimate for the predicted amount of deposit assets, wherein the final estimate is determined to be in proportion with an estimated total of individual or household deposits; and
allocating resources, based on the determination, to a geographic area and time.

9. The method of claim 8, further comprising normalizing results from the sub-model.

10. The method of claim 8, further comprising capping accounts based on an upper limit of deposit balances.

11. The method of claim 8, further comprising smoothing the deposit balances over twelve months to adjust for seasonality.

12. The method of claim 8, wherein allocating resources includes scheduling support resources for an expected type of use of the financial institution.

13. The method of claim 8, wherein allocating resources includes scheduling availability of network resources.

14. The method of claim 8, wherein the mathematical transformation includes a probability integral transform.

15. A computer processing system comprising:
a memory configured to store instructions; and
a hardware processor operatively coupled to the memory for executing the instructions including:
training a sub-model, executed by one or more processors, on accounts existing for a time at a financial institution based on deposit balances associated with the accounts during a time window to predict synthetic balances associated with the accounts;
generating, by the sub-model executed by the one or more processors, a prediction of synthetic balances for each account associated with a deposit account at the financial institution;
generating, by the sub-model executed by the one or more processors, a prediction of synthetic balances for individuals in a geographic area;
transforming, a computer program executed by one or more processors, with a mathematical transformation, the predicted amount of deposit assets to match a corresponding percentile range defined in a publicly available household asset survey or benchmark;
determining, by the computer program, a final estimate for the predicted amount of deposit assets, wherein the final estimate is determined to be in proportion with an estimated total of individual or household deposits; and
allocating resources, based on the determination, to a geographic area and time.

16. The method of claim 15, further comprising normalizing results from the sub-model.

17. The method of claim 15, further comprising capping accounts based on an upper limit of deposit balances.

18. The method of claim 15, further comprising smoothing the deposit balances over twelve months to adjust for seasonality.

19. The method of claim 15, wherein allocating resources includes scheduling support resources for an expected type of use of the financial institution.

20. The method of claim 15, wherein the mathematical transformation includes a probability integral transform.
